(19) United States
(12) Patent Application Publication
(10) Pub. No.: US 2023/0157435 A1
(43) Pub. Date: May 25, 2023

(54) COSMETIC AND SKINCARE APPLICATOR

(71) Applicant: Je Matadi, Inc., Stafford, TX (US)

(72) Inventor: Pershant Mehta, Houston, TX (US)

(21) Appl. No.: 17/993,790

(22) Filed: Nov. 23, 2022

Related U.S. Application Data
(60) Provisional application No. 63/282,423, filed on Nov. 23, 2021.

(51) Int. Cl. A45D 34/04; B05B 7/24; G01S 17/89; G01S 17/86; A45D 44/00

(52) U.S. Cl. CPC A45D 34/04; B05B 7/2402; G01S 17/89; G01S 17/86; A45D 44/005; A45D 2044/007

(57) ABSTRACT

A device may receive data from a portable applicator as the applicator moves from a first position from a user to at least a second position from the user. The device may process the data to create a map of the user and transmit the map to a display on a remote computing device, wherein the user is permitted to select one or more target profiles to be applied to the user via the portable applicator. The device may transmit a signal to the portable applicator when the user makes a selection and commence dispensing of the selected target profile in an atomized mist on the user.

### CLAIM OF PRIORITY UNDER 35 U.S.C § 119

The present application for patent claims priority to U.S. Provisional Application No. 63/282,426 entitled “COSMETIC AND SKINCARE APPLICATOR”, filed Nov. 23, 2021. This provisional application is assigned to the assignee hereof and hereby expressly incorporated by reference herein.

### FIELD OF THE DISCLOSURE

The present disclosure relates generally to cosmetic devices. In particular, but not by way of limitation, the present disclosure relates to systems, methods and apparatuses for an improved cosmetic and skincare applicator for applying a thin layer of atomized cosmetic fluid.

### DESCRIPTION OF RELATED ART

Airbrush makeup was used as early as the 1930's in Hollywood makeup studios. More widespread use in salons and homes didn't appear until the 1970's. During most of this time, the airbrush has retained a somewhat consistent shape and operation with a pen-type format passing compressed air across a venturi and causing a localized pressure reduction. This pulls media from a media reservoir and the high velocity of air atomizes the media and expels it through a nozzle. The amount of atomized media leaving the nozzle can be controlled by a user moving a needle that opens and closes a circular aperture in the nozzle. Different sized needle and nozzle combinations can also influence a spread of atomized media as well as the level of atomization. Air is typically provided from a remote compressor via a hose. One example of a pen-style airbrush is shown in U.S. Pat. No. 8,882,000, assigned to Je Matadi Inc., and incorporated herein by reference.

Recently, attempts have been made to combine the compressor and airbrush into a single mobile unit that is easier to use, especially for cosmetic applications. For instance, see TEMPTU Inc.'s U.S. Pat. No. 10,264,868, which includes batteries, a DC motor, and an air pump assembly within a single spraying apparatus.

### SUMMARY

In some aspects, the techniques described herein relate to an applicator, including: one or more sensors configured to provide real-time mapping data as the applicator moves from a first position relative to a user's face or body to at least a second position relative to the user's face or body; a head component including: at least one media reservoir configured to contain at least one media, a reservoir lid positioned above the at least one media; a nozzle including a tubular structure configured to facilitate passage of the at least one media from the at least one media reservoir; a head control system coupled to and controlling a position of a needle within the nozzle; wherein the needle is in concert with the nozzle effectuate atomization of the at least one media as the at least one media exits the nozzle; a cap positioned at least partially downstream of the nozzle and configured to facilitate passage of the at least one media from the applicator, wherein the cap includes a sub-cap positioned within the cap and around at least a portion of the nozzle and is configured to increase pressure at a tip of the nozzle; and an air constriction component positioned upstream from the tip of the nozzle and configured to present a reduction in diameter of a passage area; and a body component removably engaged with the head component, wherein the body component includes: an air source configured to supply pressurized air through the passage area, wherein the at least one media is atomized via the pressurized air and exits the applicator through the cap; one or more circuitry components housing at least one hardware processor and configured to distribute power from a power source within the applicator.

In some aspects, the techniques described herein relate to a device, wherein the one or more sensors include at least one of a Light Detection and Ranging (LIDAR) sensor and one or more cameras.

In some aspects, the techniques described herein relate to a device, wherein the head control system includes a solenoid for converting inputs of a flow control lever into movements of the needle.

In some aspects, the techniques described herein relate to a device, wherein the cap further includes: an ovular opening with a center of the ovular opening offset from the nozzle in a vertical direction, wherein the offset is configured to adjust a spray pattern of the atomized media in an upward direction relative to the nozzle.

In some aspects, the techniques described herein relate to a device, wherein the applicator reduces functionality from two to one speed when a battery charge falls below a threshold.

In some aspects, the techniques described herein relate to a device, wherein the head component and the body component are joined by a keyed coupling assembly, the keyed coupling assembly including: a plurality of protrusions and a plurality of recesses configured to mate the head component and the body component, wherein: the plurality of recesses are further configured to permit vertical mating of the plurality of protrusions of the head component with the plurality of protrusions of the body component when the plurality of protrusions and the plurality of recesses are in alignment, and rotation of the head component or the body component past a first, predefined degree of rotation will decouple the head component from the body component.

In some aspects, the techniques described herein relate to a device, wherein the air source is an air pump positioned within the body component and configured to operate within a pressure range of 12-24 PSI or between 15-20 PSI and an air flow range of 5-8 LPM.

In some aspects, the techniques described herein relate to a device, wherein the applicator further includes at least one selector configured to allow a user to power on and power off the applicator and select between two or more powered modes of the air source, wherein: a first mode of the two or more powered modes includes a first air speed or motor RPM, and a second mode of the two or more powered modes includes a second air speed or motor RMP greater than the first mode.

In some aspects, the techniques described herein relate to a device, wherein the at least one media reservoir further includes two or more sub-chambers, wherein the two or more sub-chamber are configured to contain at least one media in each sub-chamber.

In some aspects, the techniques described herein relate to a device, wherein outputs of the two or more sub-chambers are mixed in different ratios to achieve different output colors for the applicator.

In some aspects, the techniques described herein relate to a system configured for applying cosmetics, the system including: one or more hardware processors configured by machine-readable instructions to: receive data from one or more sensors of an applicator in real time as the applicator moves from a first position relative to a user's body to at least a second position relative to the user's body; process the data to determine a data map of the user; and transmit the data map of the user to a remote computing device including a display, the computing device configured to receive user inputs related to application of one or more media to a portion of the user's body corresponding to the data map; wherein the display presents the data map of the user and is configured to permit the user to select one or more target profiles, the one or more target profiles including at least one virtual overlay of one or more media as applied to the user; transmit the selected target profile to a machine-learning model, wherein the machine-learning model is configured to identify and store the selected target profile for future selections and is further configured to assist the user in selecting and effectuating application of the one or more target profiles with the applicator; use the selected target profile and feedback from the machine-learning model, to control a rate or pressure of air expelled from an air source in the applicator as well as a position of a needle in the applicator, the rate or pressure of air and needle position influencing the applicator's spray pattern to assist the user in effectuating the target profile.

In some aspects, the techniques described herein relate to a system, wherein a head of the applicator is removable from a body of the applicator and includes a head control system that converts user inputs into movement of the needle.

In some aspects, the techniques described herein relate to a system, wherein the head control system mechanically couples a lever to the needle.

In some aspects, the techniques described herein relate to a system, wherein the head control system receives a user input, digitizes the user input, and controls a position of the needle based on the digitized input.

In some aspects, the techniques described herein relate to a system, wherein a head and a body are joined by a keyed coupling assembly, the keyed coupling assembly including: a plurality of protrusions and a plurality of recesses configured to mate the head and the body, wherein: the plurality of recesses are further configured to permit vertical mating of the plurality of protrusions of the head with the plurality of protrusions of the body when the plurality of protrusions and the plurality of recesses are in alignment, and rotation of the head or the body past a first, predefined degree of rotation will decouple the head from the body.

In some aspects, the techniques described herein relate to a system, wherein the at least one media reservoir further includes two or more sub-chambers, wherein the two or more sub-chamber are configured to contain at least one media in each sub-chamber.

In some aspects, the techniques described herein relate to a system, wherein outputs of the two or more sub-chambers are mixed in different ratios to achieve different output colors for the applicator.

In some aspects, the techniques described herein relate to a non-transient computer-readable storage medium having instructions embodied thereon, the instructions being executable by one or more processors configured to perform a method for applying cosmetics, the method including: receiving a target profile including at least one preselected user input; and dispensing at least one media from at least one media reservoir in an applicator, wherein the dispensing includes: scanning a portion of a user's body via one or more sensors positioned on the applicator, wherein the one or more sensors are configured to provide readings of distance and angle or position of the applicator in real time as the applicator moves from an initial position relative to the user's body to at least a second position relative to the user's face or head, developing a map of the portion of the user's body, by comparing the readings to a datastore on a computing device; instructing an air source to pass pressurized air through a channel in a head portion of the applicator that passes an orifice on a bottom of the at least one media reservoir, this air movement drawing additional media into the channel, the air source being in the body portion of the applicator and the at least one media reservoir and channel being in a head portion of the applicator, and instructing an actuator of a head control system to position a needle within the channel to pass the at least one media through a nozzle and through a cap in the head portion at a rate and an angle of spread corresponding to the (1) target profile, (2) the map of the portion of the user's body, and (3) the readings of the one or more sensors in real time, wherein the at least one media is atomized into a mist as it exits the applicator.

In some aspects, the techniques described herein relate to a non-transient computer-readable storage medium, wherein the head control system further includes: a media flow control lever configured to manually control the rate of flow of media from the at least one media reservoir.

In some aspects, the techniques described herein relate to a non-transient computer-readable storage medium, wherein the head and the body are joined by a keyed coupling assembly, the keyed coupling assembly including: a plurality of protrusions and a plurality of recesses configured to mate the head and the body, wherein: the plurality of recesses are further configured to permit vertical mating of the plurality of protrusions of the head with the plurality of protrusions of the body when the plurality of protrusions and the plurality of recesses are in alignment, and rotation of the head or the body past a first, predefined degree of rotation will decouple the head from the body.

In some aspects, the techniques described herein relate to a non-transient computer-readable storage medium, wherein the at least one media reservoir further includes two or more sub-chambers configured to contain the at least one media in each sub-chamber, and at least one dividing structure configured to separate the at least one media in each sub-chamber.

In some aspects, the techniques described herein relate to a non-transient computer-readable storage medium, wherein the computing device is in the body of the applicator.

In some aspects, the techniques described herein relate to a non-transient computer-readable storage medium, wherein the computing device is remote from the applicator.

### BRIEF DESCRIPTION OF THE DRAWINGS

The objects, features, and attendant advantages of the present disclosure are fully appreciated as the same becomes better understood when considered in conjunction with the accompanying drawings.

FIG. 1 illustrates an isometric view of an assembled applicator according to an embodiment of the present disclosure;

FIG. 2 illustrates a rear isometric view of an assembled applicator according to an embodiment of the present disclosure;

FIG. 3 illustrates a partially assembled applicator in a partially coupled orientation according to an embodiment of the present disclosure;

FIG. 4 illustrates a disassembled applicator according to an embodiment of the present disclosure, wherein a head portion and a body portion are separated;

FIG. 5 illustrates an exemplary keyed coupling assembly of an applicator according to an embodiment of the present disclosure;

FIG. 6 illustrates a bottom view of a head portion of an applicator according to an embodiment of the present disclosure;

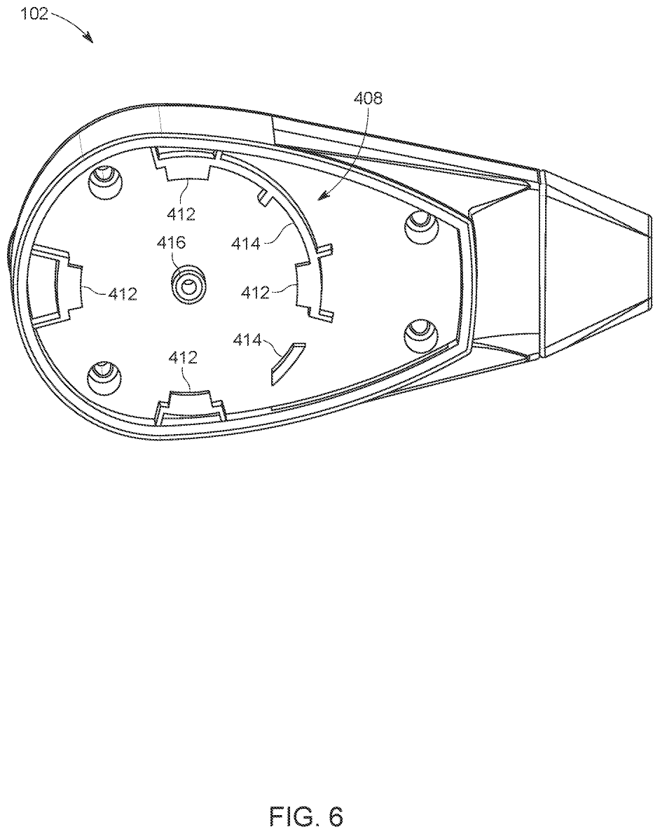

FIG. 7 illustrates exemplary internal components of a body portion of an applicator, according to an embodiment of the present disclosure;

FIG. 8 illustrates a cross section of a head portion of an applicator according to an embodiment of the present disclosure;

FIG. 9 illustrates an exemplary air constriction component of an applicator according to an embodiment of the present disclosure;

FIG. 10 illustrates an embodiment of a cap of an applicator according to an embodiment of the present disclosure;

FIG. 11 illustrates an exemplary airflow control lever and recess in a head portion of an applicator, wherein the recess is configured to fit a lever when not in a pulled back position;

FIG. 12 illustrates a reservoir lid of a head portion of an applicator according to an embodiment of the present disclosure;

FIG. 13 illustrates an exploded view of a reservoir lid with a transparent window according to an embodiment of the present disclosure;

FIG. 14 illustrates a partial rear view of an applicator according to an embodiment of the present disclosure with one or more covered charging ports and one or more vents configured to exhaust thermal energy;

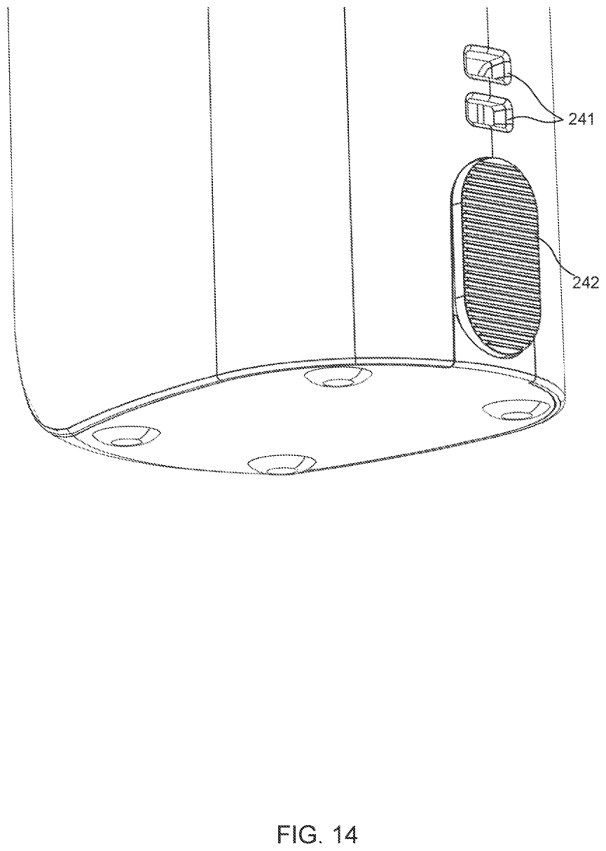

FIG. 15 illustrates a partial rear view of an applicator according to an embodiment of the present disclosure with one or more charging ports, a protective cover, and one or more vents configured to exhaust thermal energy;

FIG. 16 illustrates an embodiment of a second circuit board according to an embodiment of the present disclosure;

FIG. 17 illustrates an exemplary application of cosmetic to a user's face with the applicator moving from position A to position B;

FIG. 18 illustrates a block diagram depicting physical components that may be utilized to realize the one or more processors according to an exemplary embodiment;

FIG. 19 illustrates a flowchart depicting a method that may be executed for applying cosmetic according to an embodiment of the present disclosure;

FIG. 20 illustrates a cross section of a head portion of an applicator according to an embodiment of the present disclosure; and

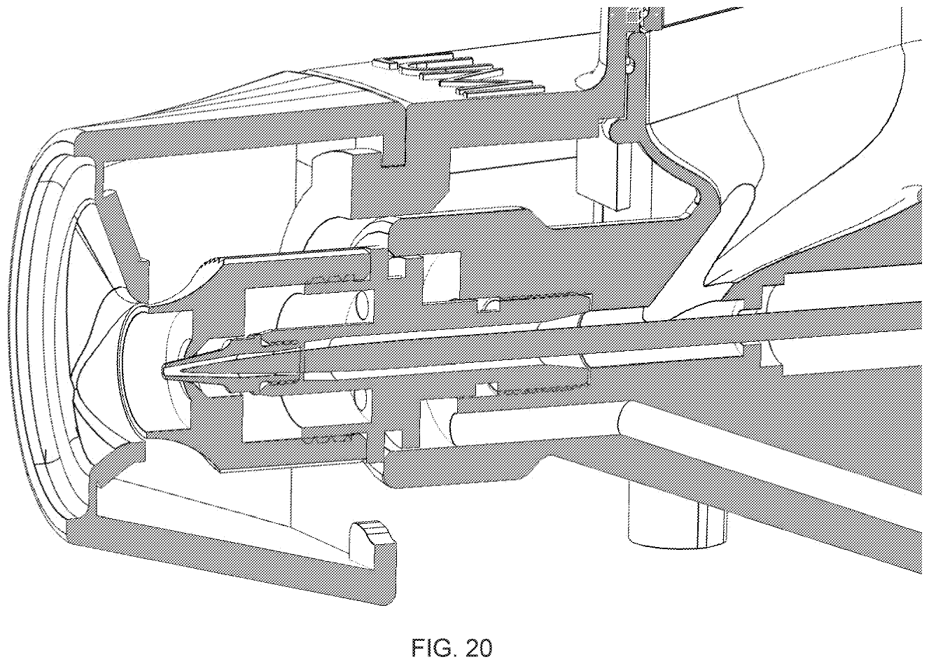

FIG. 21 illustrates an exploded view of internal components of a head portion according to one embodiment.

### DETAILED DESCRIPTION

The present disclosure relates generally to a cosmetic airbrush. More specifically, but without limitation, the present disclosure relates to a cosmetic airbrush with a more effective air supply system, nozzle, and integration with sensors and feedback loops to provide more effective and novel cosmetic application.

The word “exemplary” is used herein to mean “serving as an example, instance, or illustration.” Any embodiment described herein as “exemplary” is not necessarily to be construed as preferred or advantageous over other embodiments.

Preliminary note: the flowcharts and block diagrams in the following Figures illustrate the architecture, functionality, and operation of possible implementations of systems, methods and computer program products according to various embodiments of the present disclosure. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Additionally, the flowcharts and block diagrams in the following Figures illustrate the functionality and operation of possible implementations according to various embodiments of the present disclosure. It should be noted that, in some alternative implementations, the functions noted in each block may occur out of the order noted in the Figures. For example, two blocks shown in succession may, in fact, be executed substantially concurrently, or the blocks may sometimes be executed in the reverse order, depending upon the functionality involved.

The embodiments described below are not intended to limit the disclosure to the precise form disclosed, nor are they intended to be exhaustive. Rather, the embodiment is presented to provide a description so that others skilled in the art may utilize its teachings. Technology continues to develop, and elements of the described and disclosed embodiments may be replaced by improved and enhanced items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items, and may be abbreviated as “/”.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present. Likewise, when light is received or provided “from” one element, it can be received or provided directly from that element or from an intervening element. On the other hand, when light is received or provided “directly from” one element, there are no intervening elements present.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of the disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

This disclosure describes a makeup and skincare applicator using a venturi to pull liquid makeup into a nozzle, atomize the makeup, and expel the makeup in a fine high-speed mist. The speed and volume of makeup as well as the level of atomization can be controlled via the applicator and in some embodiments can be controlled via one or more feedback loops based on sensed data such as position and distance relative to a user's face and/or landmarks of a user's face.

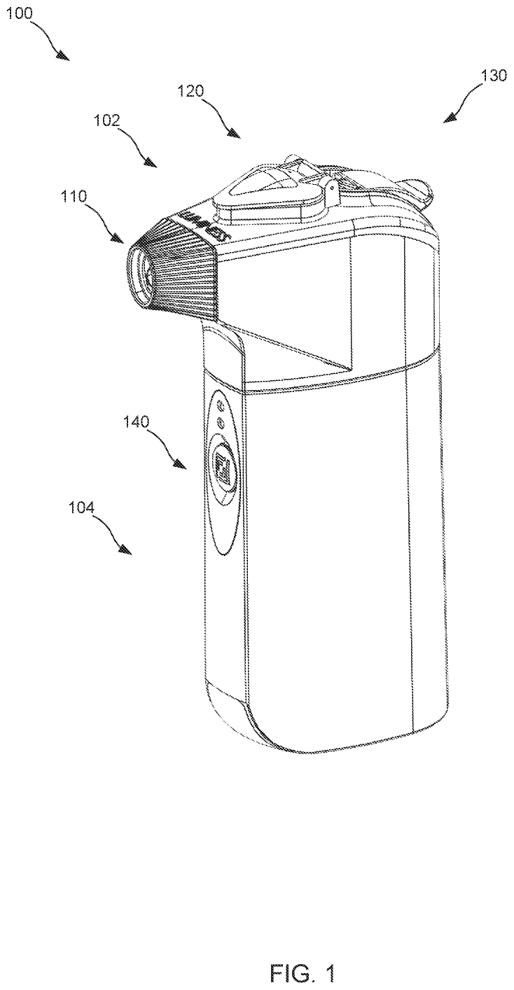

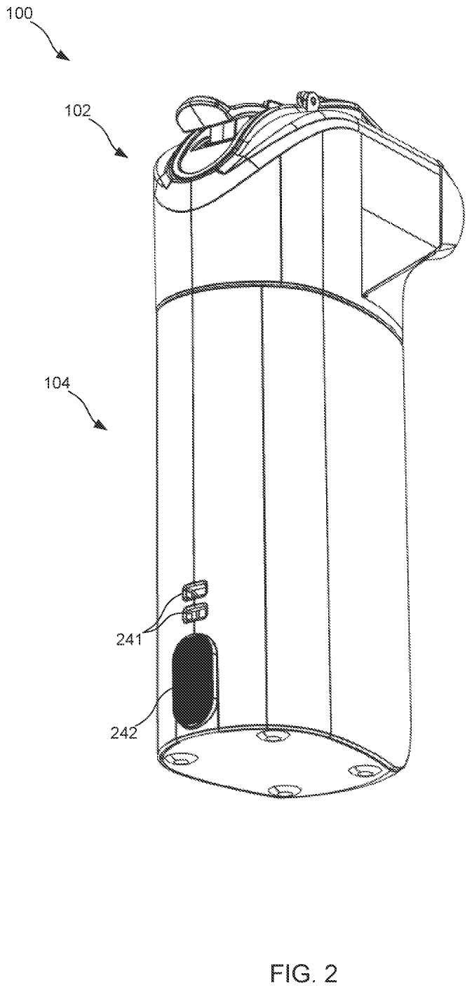

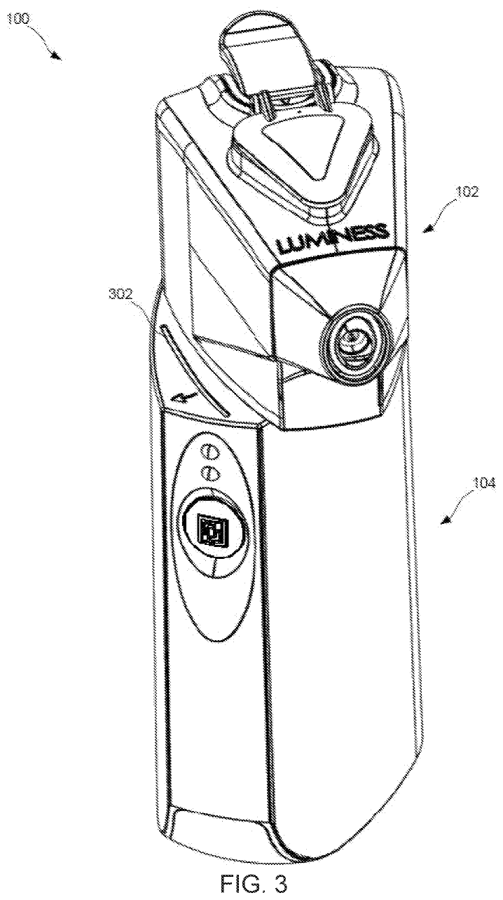

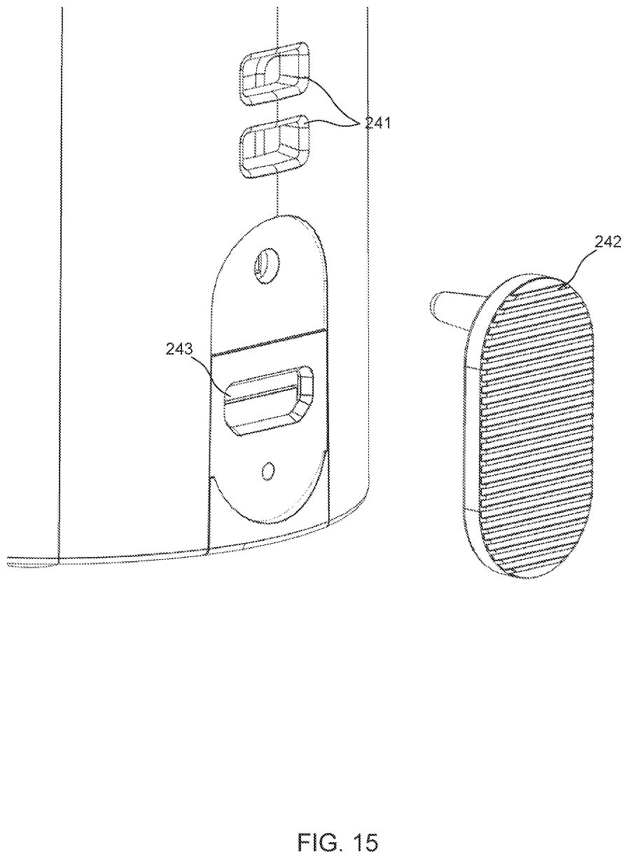

FIG. 1 illustrates an isometric view of the makeup and skincare applicator with a head 102 and body 104 removably coupled together. The makeup and skincare applicator 100, or applicator 100, comprises a head 102 and a body 104 that can be separated as shown in FIG. 3 via rotation of the head 102 relative to the body 104. In this way different heads and bodies can be interchanged, for instance where different heads are used for different applications, and/or where different bodies have different pumps or different electronics. The head 102 includes a no-mess cap 110, a reservoir assembly 120, and a trigger assembly 130, the details of which will be described further in subsequent figures and paragraphs. The body 104 includes a power assembly 140 (or where sensors are used, a power and sensing assembly 140), and although not visible from outside, a pump, battery, and other electronics within a shell of the body 104. A rear of the body 104 includes a charging port, covered by a protective cover 242 in FIG. 2, but visible in FIG. 15. The body 104 can also include one or more vents 241 for helping to exhaust thermal energy put off by the pump within the shell of the body 104. These vents 241 may also double as a loop-coupler for a lanyard or other carrying device. The vents 241 may include air filters.

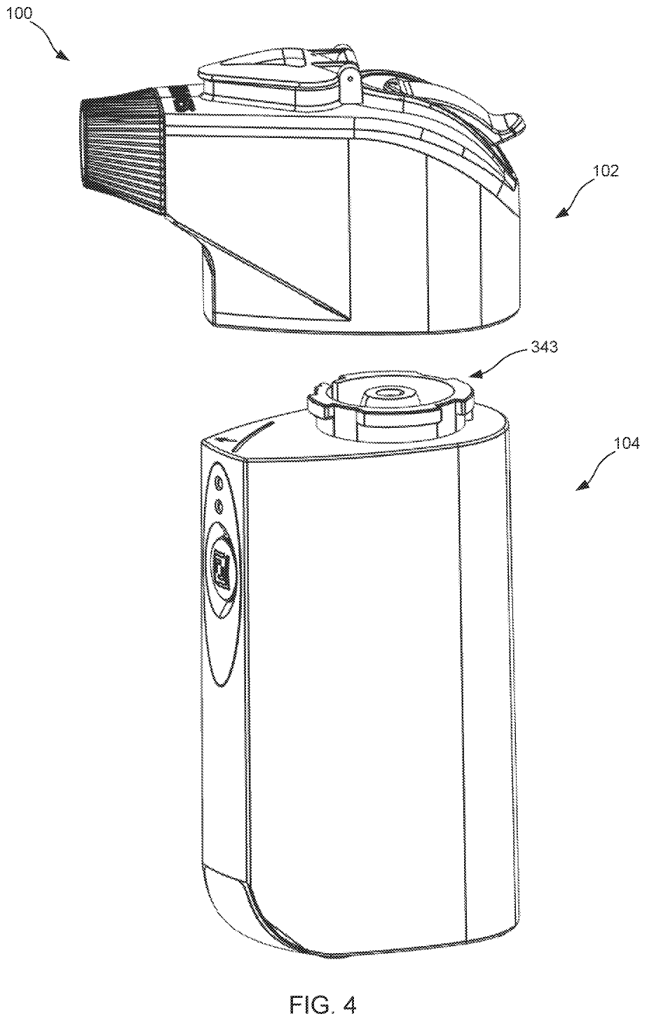

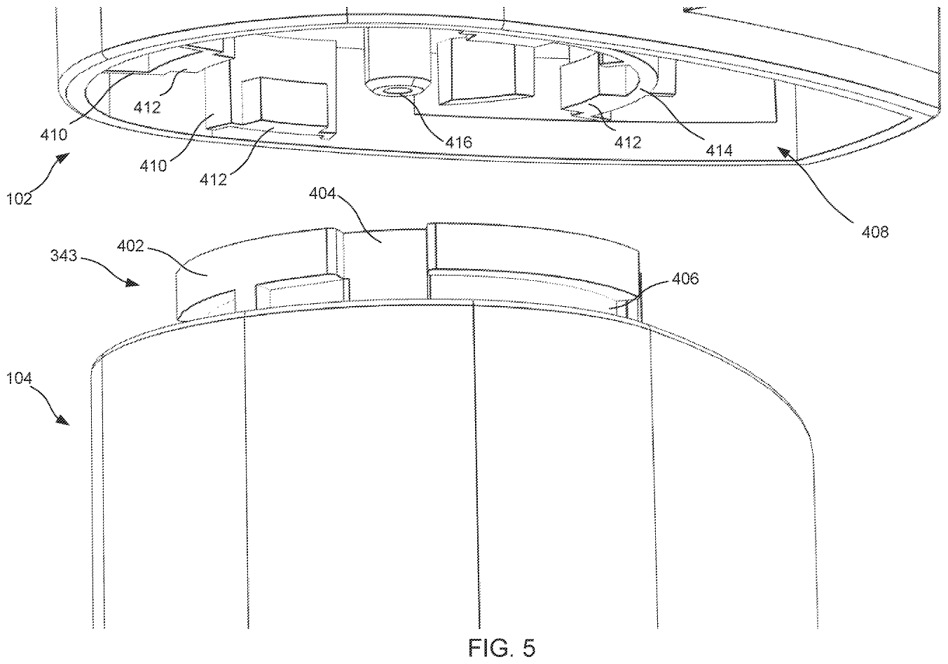

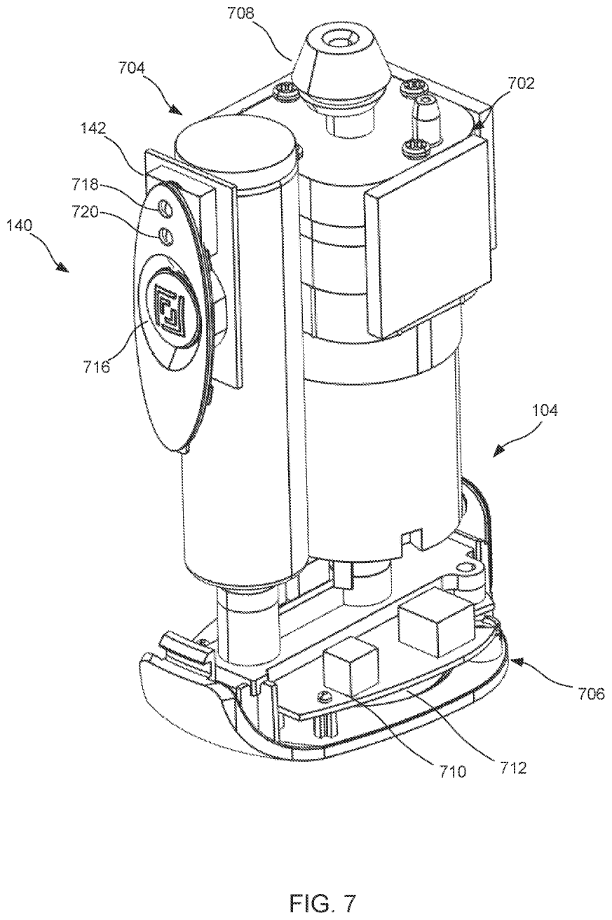

FIG. 3 shows the head and body of the applicator 100 in a partially coupled position, for instance, as might be seen during coupling or decoupling of the head to/from the body. The body 104 includes a keyed coupling assembly 343 seen in FIG. 4, that includes various protrusions and recesses that mate with similar structures in a bottom of the head 102 as seen in FIG. 5. The coupling assembly 343 allows the head 102 to be lowered onto the keyed coupling assembly 343 in a certain orientation such as seen in FIG. 3. The body 104 can include an alignment indicator or line 302 that helps a user know which angle to use when coupling the head 102 to the body 104. From the position in FIG. 3, the user can rotate the head 102, for instance about 10° or about 20° or about 30° or about 45° into a locking or engaged position as shown in FIG. 1. The applicator 102 may not be operable until the head 102 is rotated into the engaged position. This rotation may also involve a camming action that squeezes the head 102 and body 104 together and presses together an air interface between the head 102 and body 104. For instance, a bottom portion of this interface can be seen in FIG. 4 and as 708 in FIG. 7, and a top of this interface can be seen as 416 in FIG. 5. In the illustrated embodiment, the interface can include a male portion 416 and a female portion 708, though male and female orientations can easily be swapped by one of skill in the art.

FIG. 5 illustrates further details of the keyed coupling assembly and its corresponding shapes on the bottom of the head. The keyed coupling assembly 343 can include a circular structure with one or more protrusions 402 and one or more recesses 406 and 404. The recesses 404 are shaped vertically to allow protrusions 412 in the head 102 to pass the protrusions 402 in the coupling assembly 343 when these structures are aligned. This allows the head 102 to be coupled to the base 104 as well as decoupled. When the protrusions 412 are not aligned with the recesses 404, neither coupling nor decoupling can occur. This is what is meant by a keyed coupling assembly 343. The protrusions 412 are shaped to rotatably slide within the recess 406 such that the head 102 can be rotated to some extent. For instance, once the head 102 has been lowered onto the keyed coupling assembly 343, the head 102 can be rotated into a locked position. The protrusions 412 are each arranged at the same radius from a center of a circle that may be centered on the male portion 416, though this does not have to be the center of rotation. The protrusions 412 can either extend from a ring structure 414 or from sides of the head 102 via extenders 410.

FIG. 7 shows an embodiment of internals of the body shown in FIGS. 1-5. A case or shell of the body is hidden in this view to reveal the internals of the body. The body can include a battery 704 and an air pump 702. The battery 704 can provide power to the air pump 702 via connection to a first circuit board 710, and can be charged via the charging port 243 (e.g., USB type A or C, lightning, thunderbolt, or other power delivery protocol/connector). In some embodiments, wireless charging of the battery 704 is possible via an induction coil 712 or other inductive charging device. The induction coil 712 or other inductive charging device enables wireless (inductive) charging of the battery 704 when a bottom of the body 104 is arranged in proximity to another induction coil 712 or other inductive charging device. While this embodiment is described as providing power regulation through the first circuit board 710, in other embodiments power can be directly transferred between components and/or independent power regulation devices.

In some embodiments a waterproof coating is added to the first circuit board 710.

Also arranged near the bottom of the body 104 can be a first circuit board 710 (or circuit system comprising one or more boards and/or systems-on-a-chip) that can include power management circuitry for controlling charging and discharging of the battery 704 as well as manage delivery of power to the air pump 702. This power management circuitry may also manage wireless charging of the battery 704 via the induction coil 712 or other inductive charging device. In an embodiment, the air pump 702 may operate within a pressure range of 12-24 PSI or between 15 and 20 PSI and an air flow range of 5 to 8 LPM.

A second circuit board 142 (or circuit system comprising one or more boards and/or systems-on-a-chip), can be part of the power assembly 140. This second circuit board 142 may include a mechanical connection to a selector 716 (e.g., a button) or other toggle mechanism or may be in electrical communication with the same. The selector 716 is configured to allow a user to power on and off the air pump 702 as well as select between two or more powered modes of the air pump 702 (e.g., different speeds). For instance, the air pump 702 may have a first mode with a first air speed or motor RPM, and a second mode with a second air speed or motor RPM greater than the first. A third mode may be enabled that is configured for clearing the applicator 100 in the event of clogs (e.g., having a third RPM greater than the second mode). In the illustrated embodiment, a single selector 716 toggles between different modes or air speeds of the air pump 704. However, in other embodiments, multiple selectors could be used or a selector having multiple positions could be used. In other words, any selector may be implemented that allows toggling between two or more modes of the air pump 702 as well as powering on and off of the air pump 702. If the off mode is counted, then the selector 716 can toggle between three or more modes of the air pump 702.

In some cases, a waterproof coating is added to the second circuit board 142.

The second circuit board 142 can include circuits and/or circuit systems for receiving and interpreting inputs from the selector 716, and for illuminating one or more LED indicators that help inform a user of the current mode of the air pump 702. In some embodiments, the power assembly 140 can include one or more sensors, such as a Light Detection and Ranging (LIDAR) sensor 718 and one or more cameras 720. These can be used in feedback loops with a processor on the second circuit board 142, a processor within the head 102, or a remote processor, to carry out automated control of functions within the head 102 and body 104 (e.g., air pump speed, needle position, and/or angle of spray pattern). The second circuit board 142 can be couple to and receive power from the battery 704.

In some cases, a power saving program code is included in the logic of the circuit board and triggers when the system falls below a first threshold (e.g., 15%) of battery charge. When triggered, a first setting is configured to activate a power saving mode which automatically converts the applicator into a single speed device (for 2 speed systems) and uses a flashing light, such as an LED on a power button, for a predefined number of intervals, thereby indicating the applicator needs charging. When the device approaches a second threshold lower than the first (e.g., 7.5%) battery charge level the device may automatically shut off and may flash the light for a predetermined number of intervals when the user attempts to use the device, thereby indicating that the device needs to be charged before it can be used again.

In some embodiments, one or more sensors 718, 720 can be implemented to aid in a feedback loop for controlling various parameters of operation, such as air pump speed, needle position, and/or angle of spray pattern, to name some non-limiting examples.

The air pump 708 is shown with a female portion 708 of an interface that allows air from the body 104 to be transferred to the head 102 without loss of pressure. However, other means of coupling air from the air pump 708 to the head 102 can also be implemented.

Although an air pump 702 is shown and described, other means of providing pressurized air to the head can also be provided, for instance pressurized and replaceable canisters of air such as widely available CO₂ canisters.

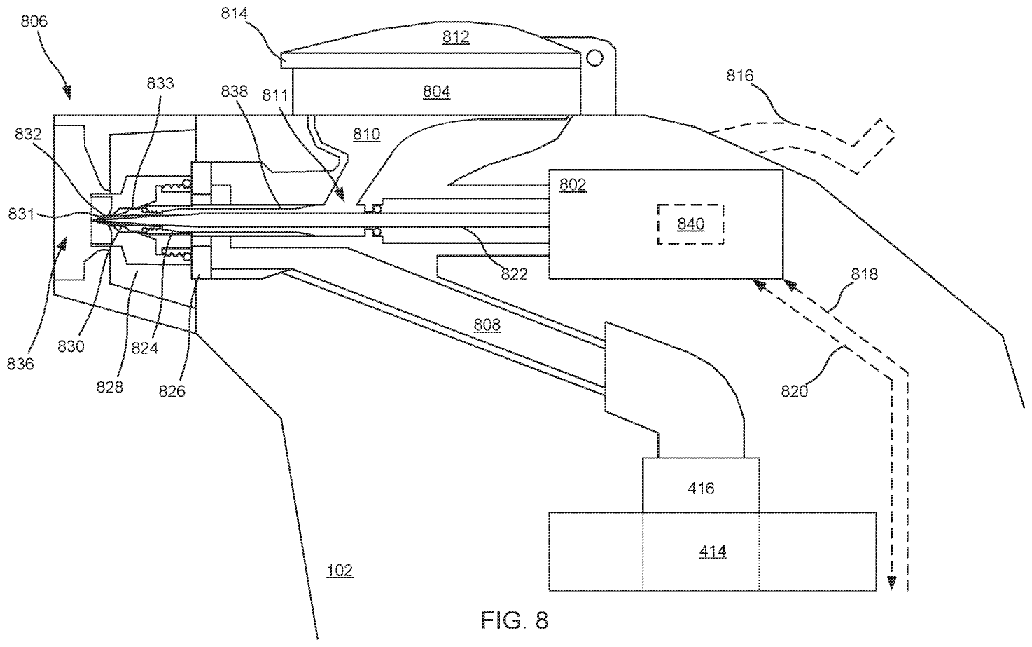

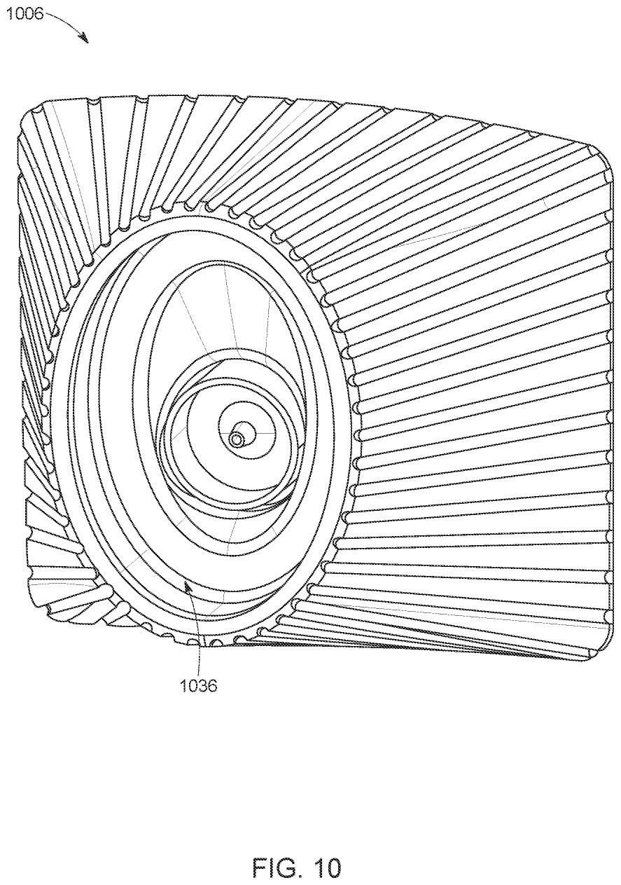

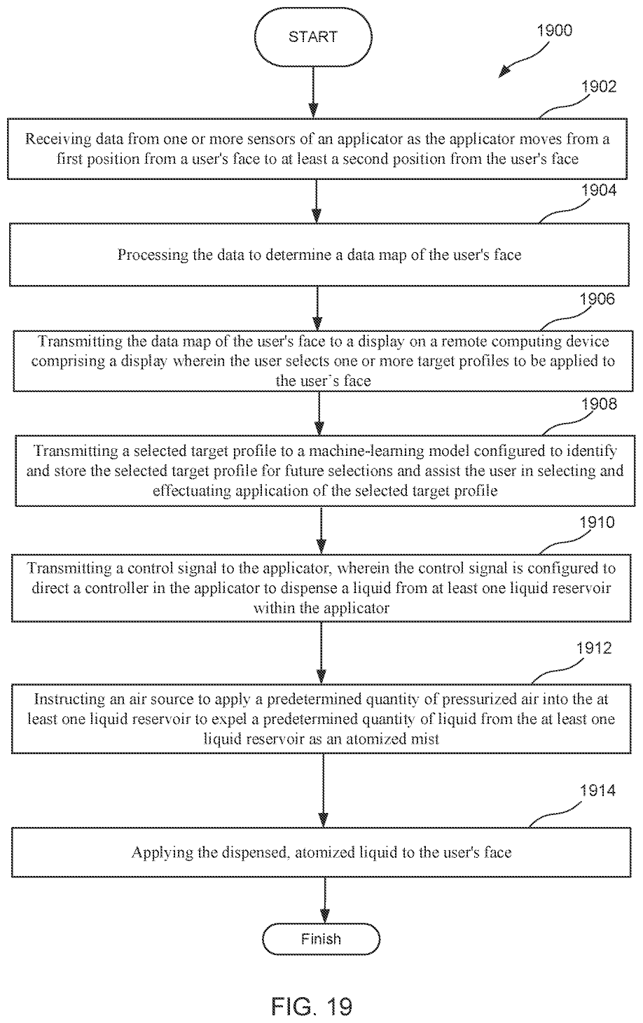

FIG. 8 illustrates a cross section of an embodiment of the head 102 and FIG. 19 illustrates an isometric view of a cross section of an embodiment of the head 102. The illustrated head 102 includes a cap 806, a needle 822 passing through a nozzle 833, a head control system 802, a reservoir 804, and an optional media flow control lever 816. A ring structure 414 can be shaped to couple with the keyed coupling assembly 343 of the body 104. The male portion 416 is shaped to couple with the female portion 708 seen in FIG. 7 and thereby allow the air pump 702 to provide pressurized air to the head 102. More specifically, pressurized air passes through a passage 808 toward the nozzle 833 and then parallel to the fluid channel 838, passes through an air constriction component 826 to further increase pressure, and then passes through a tip 831 of the nozzle 833 through an aperture made between the tip of the needle 822 and the tip 831 of the nozzle 833. When the needle 822 is release into a closed position, this aperture is sealed, and no liquid can escape. The aperture allows media to be pulled from the tip 381 of the nozzle 833 and atomized and propelled. The cap 806 includes a cone shaped chamber 836 into which the atomized media first passes and expands after being expelled from the nozzle 833. The cone shaped chamber 836 can be shaped to enhance atomization as well as control a spray pattern of the applicator as further discussed relative to FIG. 10. The nozzle 833 can have a tapered region 832 near the needle tip 831 that increases a pressure of fluid as it approaches the nozzle tip 831. Different nozzles 833 can be used with different media, for instance one having a first diameter for atomizing skincare fluids and a second having a second diameter for atomizing makeup and hair fluids, where the second diameter is larger than the first diameter. In other words, larger orifice diameters can be used for more viscous fluids. As such one non-limiting example, the first orifice diameter could be around 0.3 mm while the second orifice diameter could be around 0.4 mm. When implemented, the optional media flow control lever 816 is coupled to the needle 822 and can pull the needle 822 back (to the right in FIG. 8) when the media flow control lever 816 is pulled back. As the needle 822 is pulled back, a donut-shaped aperture opens at the end of the nozzle 833 and when air from the passage 808 passes over the tip of the nozzle, media in the fluid passage 824 is pulled from the tip of the nozzle 833 and atomized in the cone shaped chamber 836. The fluid passage 824 passes from below the lower portion 810 parallel with the needle 822, through the air constriction component 826, and finally through the nozzle 833, and is thus made up of inner surfaces of three different components. The needle 822 also passes through the fluid passage 824.

The lever 816 can be biased to a closed position, and thus as the lever 816 is released and moves back toward the closed position, the needle 822 correspondingly moves forward and gradually closes off fluid flow from the tip 831 until it makes a tight seal with the end of the needle 822 and cuts of fluid flow. Regardless of the lever 816 and needle 822 position, the airflow through passage 808 and past the tip 831 is regulated by the air pump 702 in the body. Different speeds of the air pump 702 can influence the speed, spread, and atomization of high-speed mist leaving the end of the cap 806. In other words, the position of the needle 822 influences a rate of fluid pulled from the media reservoir 804 and expelled into the cone shaped volume 836, while a mode of the air pump 702 also influences the rate of fluid pulled from the media reservoir 804, but also a density of the atomized mist and an angle of spread of the escaping atomized particles. The optional media flow control lever 816 can include a finger catch, or an upwardly-turned flange at an end of the lever 816, that enhances a user's ability to pull back on the lever 816.

In some embodiments, the passage 808 can be primarily tubular with a smooth inner surface. However, in embodiments where turbulent air is desired, the passage 808 can include ripples or a textured inner surface or can even have nonlinear shape such as a spiral or other nonlinear form that breaks up laminar flow.

The optional lever 816 can be biased toward a closed position by a spring (not shown). In some cases, a dual spring can be used wherein movement of the lever 816 engages a weaker of the two springs first, and then the stronger of the two springs. In this way, a user can more easily move the lever 816 into an optimal position for spraying and be dissuaded from over-movement of the lever 816 into a fully-open position. In other words, there can be an ideal range of positions for the lever 816 and needle 822, and a dual spring configuration can help uses to find this optimal range.

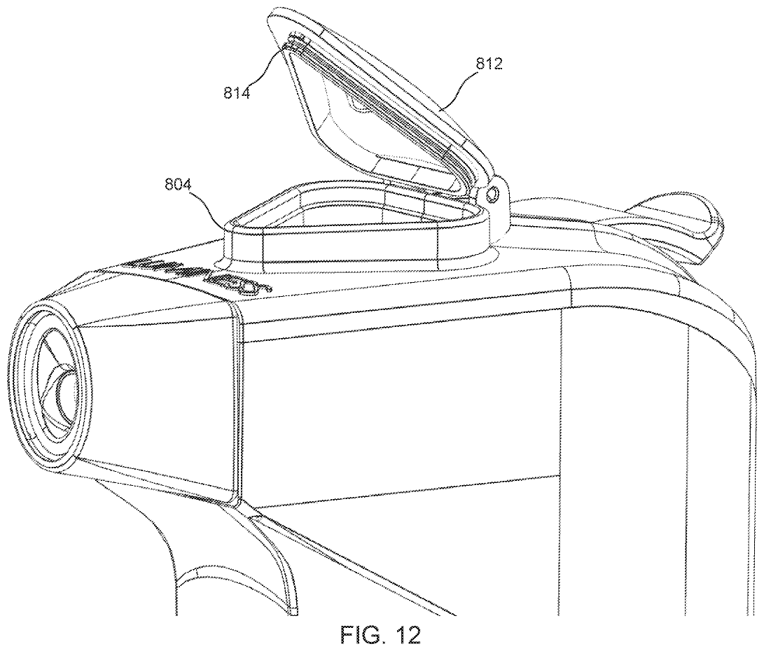

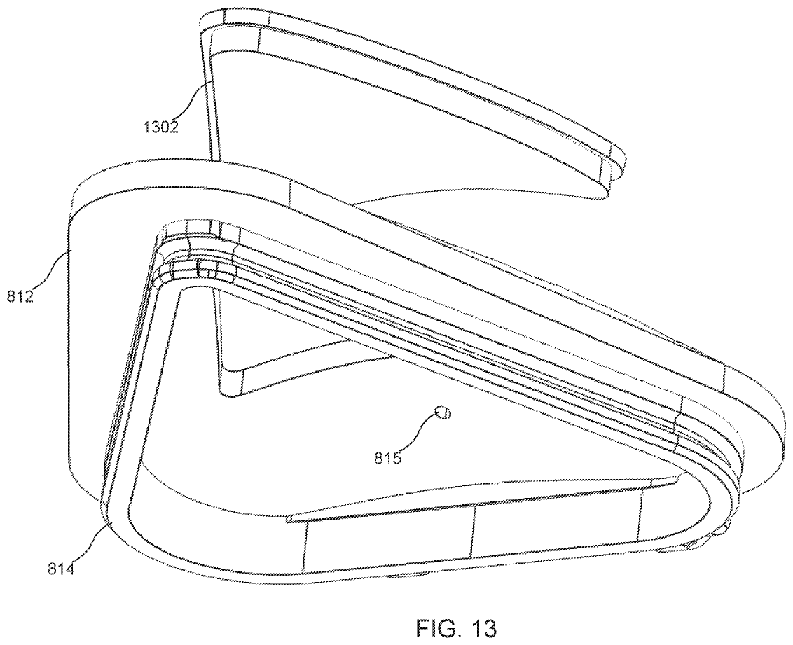

Liquids and other media can be stored in the media reservoir 804, which may include one or more side walls that can extend above a top surface of the head 102 to thereby increase a volume of the media reservoir 804. The side walls may be of varying inclines to accommodate more or less viscous liquids and other media. The media reservoir 804 can include a reservoir lid 812, and this reservoir lid 812 can rotate on a hinge to allow a user to add media to the media reservoir 804. The hinge may include a pin to reinforce the hinge and prevent the media reservoir from becoming dislodged from the applicator. The reservoir lid 812 includes a gasket 814 or other sealing structure that helps form a water-tight seal between the reservoir lid 812 and the sidewalls of the media reservoir 804 when the reservoir lid 812 is closed (best seen in FIG. 12). The gasket 814 a seal such that jostling or inverting of the applicator does not cause any loss of media from the media reservoir 804. A friction fit or snap fit can also help retain the reservoir lid 812 in a closed position. The reservoir lid 812 can also be biased into the closed position shown to thereby reduce the chances that media in the media reservoir 804 can escape during use, accidental dropping, being stored on the applicator's 100 side, etc. In some embodiments, the reservoir lid 812 can include a transparent window such as the window 1302 shown in FIG. 13. The media reservoir 804 can include one or more weep holes 815, such as the weep hole 815 in a top of the reservoir lid 812 seen in FIG. 13. In other embodiments, the one or more weep holes 815 can be arranged through the gasket 814 seen in FIG. 12, or the sidewalls of the media reservoir 804, or a combination of the above. The one or more weep holes 815 allow pressure to remain constant within the media reservoir even as media is depleted. In other words, as media is pulled into the media passage 838 and sprayed out the nozzle 833, air can be pulled through the weep hole 815 and into the media reservoir 804 to maintain pressure in the media reservoir 804. This pressure stabilization allows more consistent and accurate dosing of media into a vaporized form. A lower portion 810 of the media reservoir 804 can taper toward an exit orifice 811 that meets with the media passage 838. Further, the lower portion 810 can be sloped toward a front of the head 102 to enhance fluid flow into the media passage 838 and reduce turbulence that is caused by sharp directional changes in fluid flow. In some ways, the lower portion 810 has a funnel shape that provides gravity-assisted movement of fluid from the media reservoir 804 to the media passage 838.

In some embodiments, the media reservoir 804 can be split into two or more sub-chambers via a dividing wall such that colors or types of fluid can be separated until they are pulled down the lower portion 810 and mixed in the media passage 838. In some embodiments, each sub-chamber can include a controlled discharge interface to controllably release one or more of the sub-chambers into the media passage 838. For instance, and assuming that three sub-chambers are used, each with a different shade of cosmetic, one, two, or all three of the controlled discharge interfaces can be opened and to different extents, thereby controlling a mixing of colors to effectuate a desired color of atomized mist expelled from the apparatus. In this way, a single applicator could controllably apply different shades of cosmetic to different portions of a user's body (e.g., face) in realtime as the applicator is moved across the face (e.g., darker shades at the base and side of the nose and lighter shades along the ridge of the nose). In other embodiments, multiple liquids can be mixed in the media reservoir 804 before use. Mixing can be performed via various methods, including, but not limited to, ‘back bubbling’, a process wherein a user covers the opening in the cap 806 with a finger or other object and pulls back on the optional lever 816 thereby driving air backward through the nozzle and up into the media reservoir 804 to create air bubbles in the media reservoir 804 that turbulently mix the contents therein.

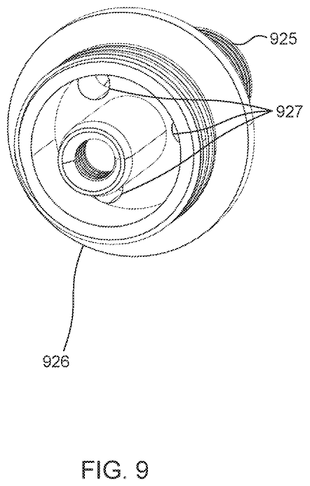

An air constriction component 826 can be arranged concentrically around the nozzle 833 and can constrict airflow from the passage 808 before it reaches an end of the nozzle 833. The air constriction component 826 can be positioned upstream from the tip of the nozzle 833 and can present a smaller area, or diameter, for air to pass through than does the passage 808 and in this way the air constriction component 826 increases air pressure reaching the nozzle 833. FIG. 9 shows an embodiment of the air constriction component 926 and this version includes three holes spaced at a radius from a center longitudinal axis of the air constriction component 926. These holes 927 form an air passage much smaller in area than the area formed just before the air constriction component 926 and this increases the pressure on the downstream side of these holes. In this way the air constriction component 926 increases a pressure at the end of the nozzle effectively increasing the vaporization capability of the applicator for a given air pump RPM. FIG. 9 represents just an exemplary form of the air constriction component 926 and other constriction shapes and structures can be used in FIG. 8. For instance, more than three holes could also be implemented and/or different sized holes could be used. Along these same lines, a porous membrane could even be used so long as the air pressure is increased by the membrane, but not overly so. Alternatively, fewer than three holes could be implemented. Whatever, structure is used to constrict the airflow, the design focus will be on reducing an overall cross section for air to pass through as compared to the passage 808.

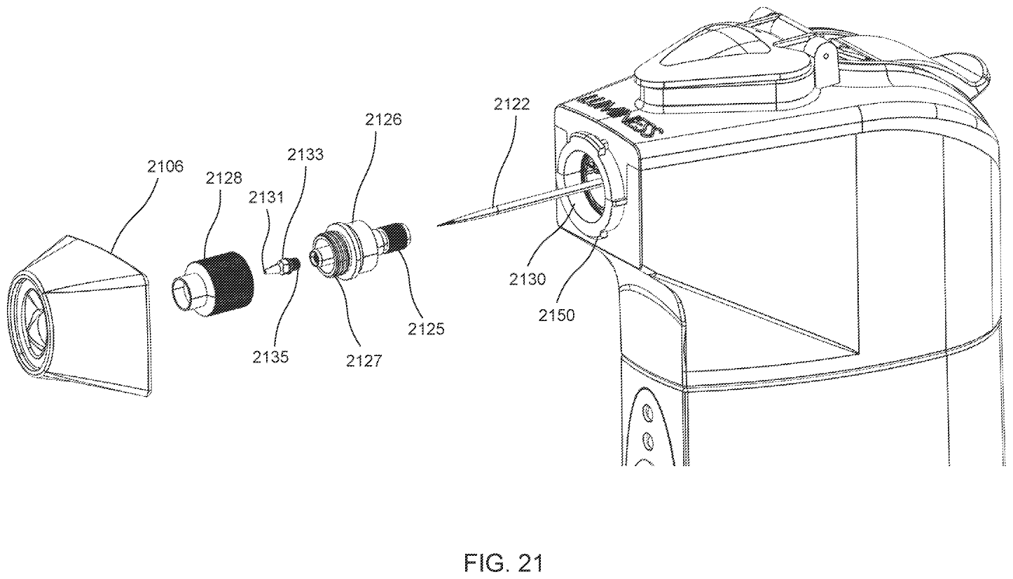

The illustrated air constriction component 826/926 can thread into the head 102, for stance, via the male threads 925 illustrated in FIG. 9. As illustrated in FIG. 9, the air constriction component 926 also includes a second set of threads 927 that various components can rotatingly engage with. The cap 906 can couple to the head via flanges as seen best in FIG. 21.

A sub-cap 828 can be arranged around at least a distal end of the nozzle 833, and includes a constriction 830 that helps to further increase pressure at the nozzle 833 tip.

In some embodiments, the head control system 802 can include coupling structures for connecting the lever 816 to the needle 822. In other embodiments, the head control system 802 can include electromechanical structures and control that enhance or supplement action of the lever 816. For instance, the lever's 816 motion can be digitized in the head control system 802 and used in combination with feedback from sensors, such as LIDAR and a camera (e.g., 718 and 720, respectively) to control operation of the head 102. For instance, this feedback could be used in a type of ‘autopilot’ scheme where a user's spraying technique is enhanced by the head control system 802 making automated adjustments based on feedback from the sensors. As just one non-limiting example, regardless of a user's pulling on the lever 816, the head control system 802 may close the needle 822 when sensors indicate that the cone of spray is in line with a user's eyes, mouth, or hair. The head control system 802 may include an optional needle controller 840 configured to control a servo or other electro-mechanical device that can move the needle 822 in response to signals from the head control system 802. For instance, movement of the optional lever 816 can be translated into movement of the needle 822 through the optional needle controller 840. Alternatively, the sensors may provide feedback, such that a given lever 816 position may result in differing effects on the needle 822. For instance, if the sensors indicate that the applicator 100 is too close to a user's face or other body part, the needle 822 position may not be pulled back as far for a given lever 816 position, and in this way the applicator 100 can compensate for user errors in holding the applicator 100 too close to the face or other body part. In these embodiments, a solenoid or a similar electromechanical device can be controlled to move the needle 822. Similar feedback can be used to smooth or dampen user inputs, for instance, by making smoother adjustments to needle 822 position than those that would directly correspond to movements of the lever 816.

In another embodiment, the optional control lever 816 can be foregone, and the head control system 802 can solely control the needle 822, for instance via a solenoid.

Whether or not the optional control lever 816 is used, a solenoid or similar electromechanical structure can be arranged in the head control system 802 or in the body. Where a solenoid or similar electro-mechanical structure is arranged in the body, a mechanical link from the body to the needle 822 in the head 802 can move the needle 822. In some cases, power for this mechanical link can come from the air pump and in others it can come from another electro-mechanical structure, such as, but not limited to a solenoid powered by the battery in the body or another power source. In other cases, a vacuum can be created in the head 102 that moves the needle 822.

Data from the sensors may arrive via optional control line 820 that is configured for coupling to a corresponding data line in the body 104. Power is provided to the head control system 802 via an optional power line 818, that may be connected, for instance, to the battery in the body.

FIG. 10 illustrates an embodiment of a cap such as the cap 806 seen in FIG. 8. The cap 1006 can include an ovular opening 1007 with a center of the ovular opening 1007 offset from the nozzle in a vertical direction. The result of this offset is that the spray pattern is aimed slightly upward from one aligned with a longitudinal axis of the nozzle and needle. Further, the opening 1007 includes a lip 1036 that helps collect drips and prevent them from falling onto a floor or the user—hence the cap 1006 can be referred to as a no-mess cap. The shape of the opening 1007 also helps to capture drips via surface tension and hold them in place to prevent them from falling from the no-mess cap 1006.

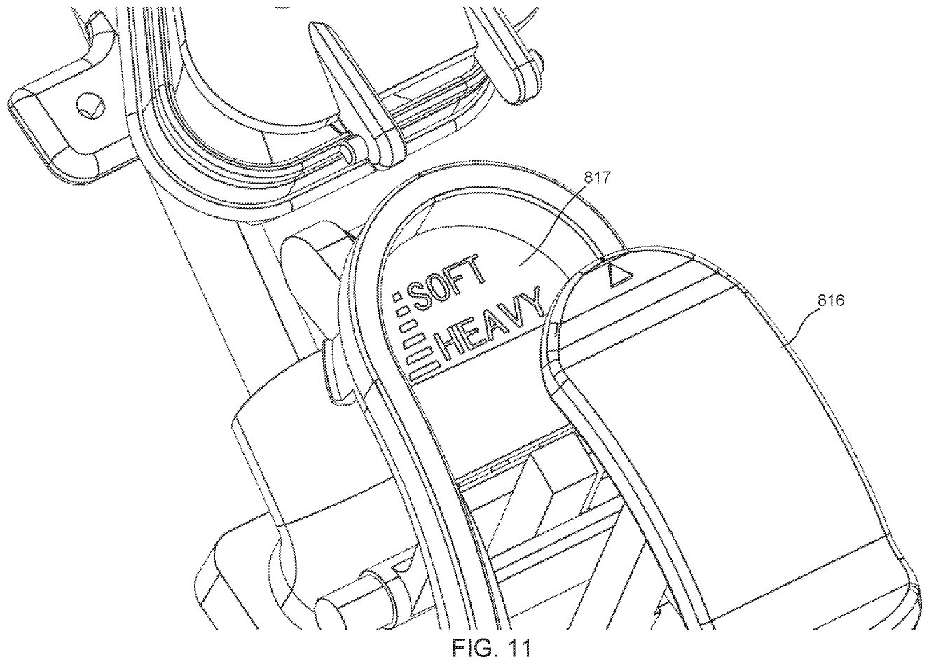

FIG. 11 illustrates details of an embodiment of the optional airflow control lever 816 and a recess 817 in the head that the lever can fit into when not pulled back. The recess 817 can include writing, symbols, or other imagery to help a user visually know how much media is being sprayed from the applicator. For instance, as the user pulls back on the lever 816 portions of the words “SOFT” and “HEAVY” can incrementally be revealed behind the lever 816.

Although this disclosure has focused on air-assisted methods of atomizing the media, in other embodiments, piezoelectric pumps can also be used, for instance, where a voltage is applied to a piezoelectric material that is coupled to a media reservoir and where flexing of the piezoelectric material increases pressure in the media reservoir sufficiently to expel one or more atomized particles of media into a larger spray of media that is aimed at a user's body (e.g., face).

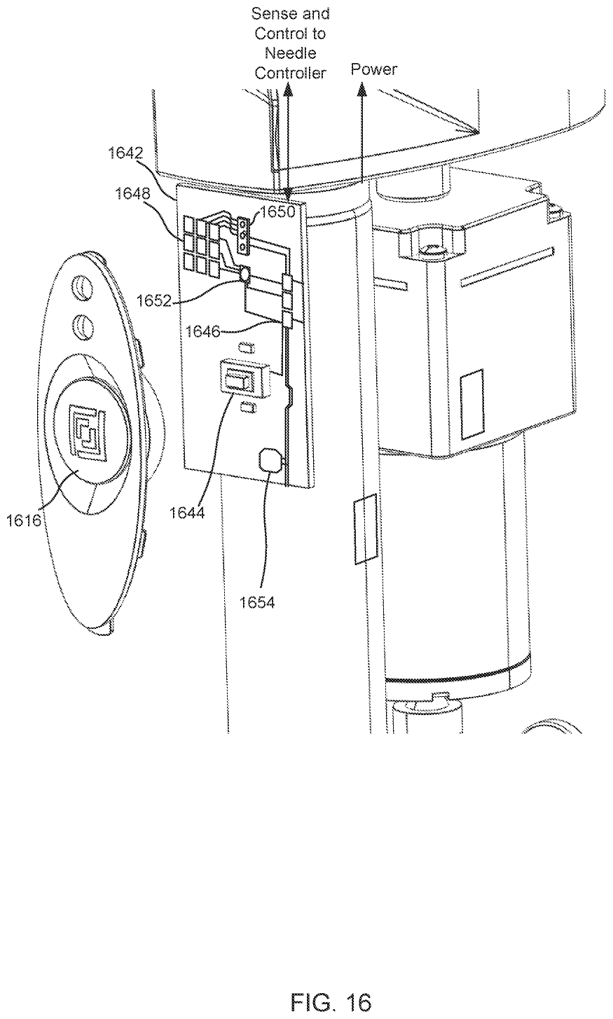

FIG. 16 shows a detailed embodiment of a second circuit board, such as the second circuit board shown in FIG. 7. The second circuit board 1642 can include a mechanical interface 1644 to a selector 1616. The mechanical interface 1644 can be in electrical communication with one or more processors 1646 and memory 1648. The memory 1648 may temporarily store signals from the mechanical interface 1644, for instance, to determine a desired mode of the air pump through a number of selector 1616 presses within a set period of time. The memory 1648 may also be configured to store processor routines to execute by the one or more processors 1646 in response to signals from the mechanical interface 1644. The one or more processors 1646 may also be in electrical communication with one or more sensors, such as a LIDAR sensor 1650 and a camera sensor 1652. The one or more processors 1646 may be configured to analyze data from the LIDAR sensor 1650, the camera sensor 1652, and the mechanical interface 1644. Additionally, the one or more processors 1646 may also use relative position or orientation date (e.g., from one or more gyros or accelerometers) as well as data about needle position. A type of media in the media reservoir may also be taken into consideration (e.g., greater pressure is needed to atomize thicker fluids). All of these inputs may be analyzed to produce control signals that can be sent to the needle controller, such as the needle controller 840 in FIG. 8. The one or more processors 1646 may also control the mode or RPM of the air pump. The second circuit board 1642 may also include a wireless antenna 1654 such as but not limited to one operating in the 2-6 GHz region (e.g., BLUETOOTH). In alternate implementations, some or all of the processing done by the one or more processors 1646 may be offloaded to a remote device such as a cell phone, tablet computer, laptop computer, or even cloud-based processing, via wireless communication. For instance, the antenna 1654 could be used to transmit sensor data to a remote computing device that can process the feedback and generate instructions to be sent back to the applicator and passed from the antenna 1654 to a respective component such as a solenoid for controlling the needle or a controller for changing a state of the air pump. Typically, these remote devices can have greater processing resources than those arranged within the applicator, though this may not always be the case.

Similarly, sensor data can be transmitted via the antenna 1654 to a remote computing device with a display, such as a cell phone, tablet computer, laptop computer, etc. For instance, the camera can capture an image of a user, especially color and texture, while the LIDAR sensor in combination with the camera can locate shapes of the user's face or other region of the body. The remote computing device can then be used to display a target cosmetic profile and allow a user to provide inputs to that target, which can then be transmitted back to the applicator and used to control operation of the applicator to effect the target cosmetic profile. For instance, the camera 1652 could take an image of a user's face, which is then displayed on the remote computing device along with an overlay, or modified by, an image of a desired application of makeup or a hair colorant. The user could then make adjustments to the target profile, for instance altering a tone of blush or foundation used on the cheek area, but maintaining the proposed target profile in other regions of the face. This adjusted target profile could then be transmitted back to the applicator and the user could begin applying foundation, blush, hair colorant, etc. while the applicator adjusts the needle and/or air pump mode in real time to assist the user in achieving the adjusted target profile based on a position and orientation of the applicator as well as a memory of previous layers of makeup or hair product. This is just one example, and those of skill in the art can easily perceive how this feedback and user input can be used to effect numerous semi-automated applications of makeup, skin care product, and hair products.

Though two distinct circuit boards have been shown and described, in other embodiments, a single circuit board could be used, or more than two circuit boards. Further, the locations of the one or more circuit boards can be different than that shown in FIGS. 7 and 16. The functionality of each of the first and second circuit boards may also be distributed in ways other than as described. For instance, processing of signals from the LIDAR sensor and camera could occur on a circuit board arranged at the bottom of the body, such as below the air pump and battery. Alternatively, processing can be distributed between on-device processing and remote processing, such as one or more processors of a cell phone with a wireless link to the applicator.

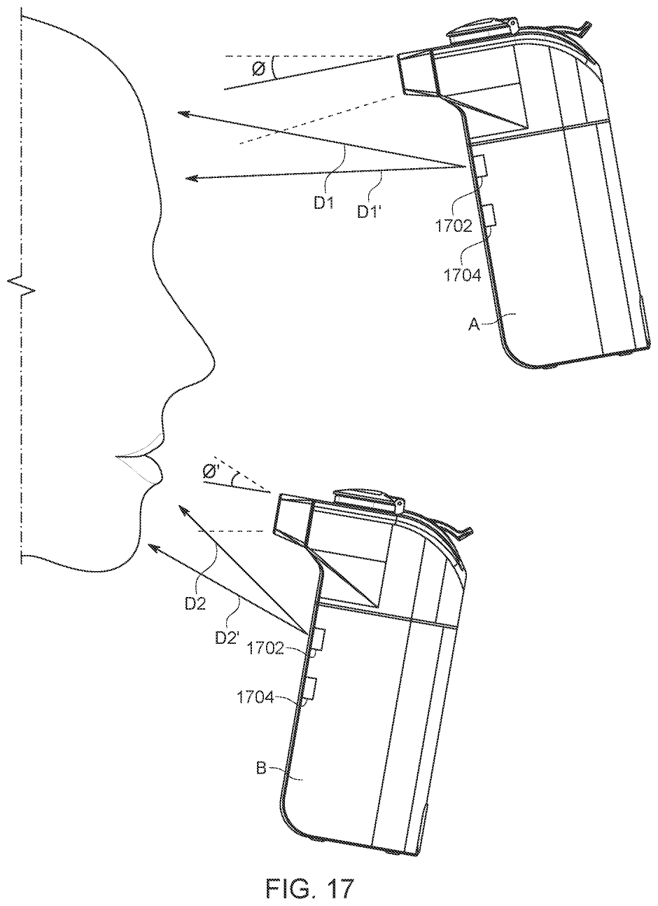

Implementation of the controls discussed in FIG. 16 can be seen, for instance, in FIG. 17, where a user's face is shown as well as first and second positions of an applicator, such as the ones discussed throughout this disclosure. The applicator can include one or more sensors such as the illustrated LIDAR sensor 1702 and the illustrated camera 1704. As the applicator is moved between positions, the LIDAR sensor 1702 can take a reading of two or more distances to the face (e.g., D1 and D1′ and D2 and D2′) at different angles to form a data map of the face for each position of the applicator. The data map can be stored in a datastore on a computing device and can use a camera 1704 in conjunction with the LIDAR sensor 1702 to form a more accurate and complete mapping of the face, for instance, by recording subtle textures, colors, and details that may have been missed by the LIDAR sensor 1702. In other words, data from the camera 1704 can supplement the data map formed by the LIDAR sensor 1702. Either way, this mapping can be used to control aspects of the applicator such as speed of the air pump, needle position, and angle of spread Ø of the atomized mist that is produced. In an embodiment, a distance to the face can be used to adjust a speed of the air pump to thereby increase a speed of air leaving the applicator when the applicator is further from the face and decrease the air pump speed when the applicator is closer to the face. In another embodiment, the position of the needle can be adjusted to change an amount of media being presented to an end of the nozzle based on a distance of the applicator from the face. The distance to the face at any given time can be a shortest distance that the LIDAR measures, an average distance measured, or a weighted distance of all measurements with measurements toward a center (or low angle relative to an axis of the needle) being more heavily weighted. In other embodiments, the LIDAR and camera may be used to recognize regions of the face and adjust settings of the applicator based on the region of the face being sprayed. For instance, the needle may be pulled back further and more media applied per second when the applicator is deemed to be aiming at the cheeks than when the applicator is deemed to be aiming at the lips, eyes, or hair. In other embodiments, the applicator may have stored in memory therein, a mapping of a target makeup profile and the applicator may adjust its settings based on this profile and the location of the applicator as it is moved around the face (e.g., from position A to position B). A target makeup profile could be one deemed to enhance the beauty of a subject, while in other instances the target makeup profile could be designed to mimic the look of another person. For instance, and especially where layers of foundation or another thick cosmetic can be repeatedly layered, the applicator may not only change skin coloration but the shape of the face via repeated application of layers. In some embodiments, two or more media reservoirs can be used each with its own controlled gate such that one or another color can be applied at a time based on the location of the applicator or mixtures of colors can be applied in differing amounts to create a variety of shades across the face. Along this same vein, one media reservoir could contain makeup while another contains a skin care product and the two can be mixed such that makeup and a skin care product can be sprayed simultaneously and in a controlled ratio. Such is not currently possible, and pre-mixing makeup and a skin care product before pouring the mixture into a classic sprayer may degrade the effectiveness of both, whereas this disclosure combines the two mediums at the last possible moment.

FIG. 21 illustrates an exploded view of internal components of a head portion according to one embodiment. In this view, the cap 2106, sub-cap 2128, nozzle 2133, air constriction component 2126, and needle 2122 have been pulled out from the head through aperture 2130 so that these components are more easily visible. The air constriction component 2126 can include male threads 2125 at a proximal end that thread into female threads inside the aperture 2130 (not visible here). A proximal end of the air constriction component 2126 includes male threads that receiver female threads on an inside of the sub-cap 2128. In turn, the air constriction component 2126 makes up a portion of the fluid channel (e.g., 838 in FIG. 8) and the tubular structure performing this role extends out a distal end of the air constriction component 2126 and include female threads that receive male threads 2135 on a proximal end of the nozzle 2133. The cap 2106 snaps or rotates onto flanges 2150 on the head. In this way, the nozzle 2133 threads into a distal end of the air constriction component 2126, the sub-cap 2128 threads onto a distal end of the air constriction component 2126, and this assembly of three components threads into the head via the male threads 2125 on a proximal end of the air constriction component (although other orders of assembly are also envisioned). Finally, the cap 2106 can be coupled to the body with a distal end of the sub-cap 2128, the nozzle 2133, and the needle 2122 extending partially out an aperture in the cap 2106.

It should be understood that the liquid and media described throughout this disclosure could be a makeup (e.g., foundation, blush, or a tanning formula), a skin care product, or a hair product (e.g., bleach or highlighter), to name a few non-limiting examples. For instance, a hair product could be applied, with feedback from the sensors, to change a color of a user's roots, while not spraying other portions of the hair, thereby coloring roots and extending the time between visits to a professional colorist.

The applicator, especially the body, may include sound deadening materials to decrease an overall decibel level of the applicator.

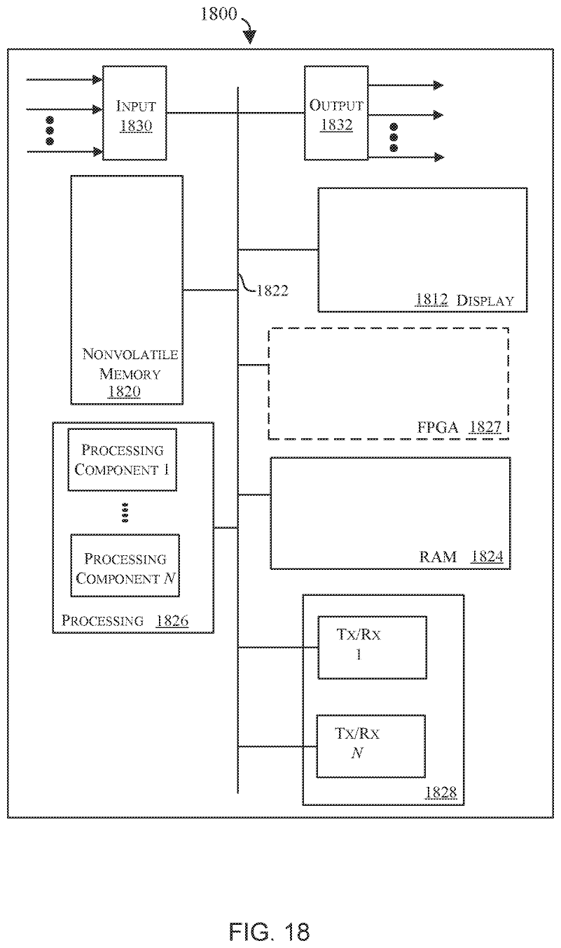

The methods described in connection with the embodiments disclosed herein may be embodied directly in hardware, in processor-executable code encoded in a non-transitory tangible processor readable storage medium, or in a combination of the two. Referring to FIG. 18 for example, shown is a block diagram depicting physical components that may be utilized to realize the one or more processors 1646 (and any control of the battery, air pump, or needle generally) according to an exemplary embodiment. As shown, in this embodiment a display portion 1812 and nonvolatile memory 1820 are coupled to a bus 1822 that is also coupled to random access memory (“RAM”) 1824, a processing portion (which includes N processing components) 1826, an optional field programmable gate array (FPGA) 1827, and a transceiver component 1828 that includes N transceivers. Although the components depicted in FIG. 18 represent physical components, FIG. 18 is not intended to be a detailed hardware diagram; thus many of the components depicted in FIG. 18 may be realized by common constructs or distributed among additional physical components. Moreover, it is contemplated that other existing and yet-to-be developed physical components and architectures may be utilized to implement the functional components described with reference to FIG. 18.

This display portion 1812 generally operates to provide a user interface for a user, and in several implementations, the display is realized by a touchscreen display. The display portion 1812 may also be implemented by one or more LEDs of the same or different colors, or having one or more blinking patterns each representative of a different mode of the air pump or another sub-component of the applicator. In general, the nonvolatile memory 1820 is non-transitory memory that functions to store (e.g., persistently store) data and processor-executable code (including executable code that is associated with effectuating the methods described herein). In some embodiments for example, the nonvolatile memory 1820 includes bootloader code, operating system code, file system code, and non-transitory processor-executable code to facilitate the execution of a method for controlling the applicator in conjunction with human operation, for instance, as shown in FIG. 17.

In many implementations, the nonvolatile memory 1820 is realized by flash memory (e.g., NAND or ONENAND memory), but it is contemplated that other memory types may be utilized as well. Although it may be possible to execute the code from the nonvolatile memory 1820, the executable code in the nonvolatile memory is typically loaded into RAM 1824 and executed by one or more of the N processing components in the processing portion 1826. For instance, the memory 1648 is a non-limiting example of the nonvolatile memory 1820, though it could also be volatile memory such as RAM 1824.

The N processing components in connection with RAM 1824 generally operate to execute the instructions stored in nonvolatile memory 1820 to enable control of the air pump and/or a servo or other electromechanical device controlling the needle position. For example, non-transitory, processor-executable code to effectuate the methods described with reference to FIG. 17 may be persistently stored in nonvolatile memory 1820 and executed by the N processing components in connection with RAM 1824. As one of ordinarily skill in the art will appreciate, the processing portion 1826 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 1826 may be configured to effectuate one or more aspects of the methodologies described herein (e.g., the method described with reference to FIG. 17 or the method for controlling air pump state as described throughout). For example, non-transitory processor-readable instructions may be stored in the nonvolatile memory 1820 or in RAM 1824 and when executed on the processing portion 1826, cause the processing portion 1826 to control a state of the air pump and/or a position of the needle based on input from the selector 716 and/or the LIDAR 718 and/or the camera 720. Alternatively, non-transitory FPGA-configuration-instructions may be persistently stored in nonvolatile memory 1820 and accessed by the processing portion 1826 (e.g., during boot up) to configure the hardware-configurable portions of the processing portion 1826 to effectuate the functions of the first or second circuit boards.

The input component 1830 operates to receive signals (e.g., a signal from the selector 716, the LIDAR 718 or the camera 720) that are indicative of one or more aspects of the user's input and/or proximity of the device to different facial features/structures or other portions of a user's body. The signals received at the input component may include, for example, analogue voltages from the selector 716 or digital signals from an analog-to-digital converter arranged between the sensors 718, 720 and the second circuit board 142. The output component generally operates to provide one or more analog or digital signals to effectuate an operational aspect of the air pump state and/or needle position. For example, the output portion 1832 may provide the air pump control signal described with reference to FIGS. 7 and 16.

The depicted transceiver component 1828 includes N transceiver chains, which may be used for communicating with external devices via wireless or wireline networks. Each of the N transceiver chains may represent a transceiver associated with a particular communication scheme (e.g., WiFi, Ethernet, Profibus, etc.).

FIG. 19 illustrates a method 1900 flowchart depicting a method for applying cosmetics, in accordance with one or more implementations of the present disclosure. The operations of the method 1900 presented below are intended to be illustrative. In some implementations, the method 1900 may be accomplished with one or more additional operations not described, and/or without one or more of the operations discussed. Additionally, the order in which the operation of the method 1900 are illustrated in FIG. 19 and described below is not intended to be limiting.

An operation 1902 may include receiving data from one or more sensors of an applicator as the applicator moves from a first position from a user to at least a second position from the user.

An operation 1904 may include processing the data to determine a data map of the user.

An operation 1906 may include transmitting the data map of the user to a display on a remote computing device comprising a display wherein the user selects one or more target profiles to be applied to the user.

An operation 1908 may include transmitting a selected target profile to a machine-learning model configured to identify and store the selected target profile for future selections and assist the user in selecting and effectuating application of the selected target profile.

An operation 1910 may include transmitting a control signal to the applicator, wherein the control signal is configured to direct a controller in the applicator to dispense a media from at least one media reservoir within the applicator,

An operation 1912 may include Instructing an air source to apply a predetermined quantity of pressurized air into a passage and expelling a predetermined quantity of media from the at least one media reservoir to be atomized into a mist in a cap of a head portion of the applicator

An operation 1914 may include applying the dispensed, atomized media to the user.

In some cases, a non-transient computer-readable storage medium having instructions embodied thereon is disclosed, the instructions being executable by one or more processors configured to perform a method for applying cosmetics, the method may comprise: receiving data from one or more sensors of an applicator in real time as the applicator moves from a first position from a user to at least a second position from the user; process the data to determine a data map of the user; and transmit the data map of the user to a remote computing device comprising a display, wherein the display may present the data map of the user and may be configured to permit the user to select one or more target profiles, the one or more target profiles may comprise at least one virtual overlay of one or more media as applied to the user; transmit the selected target profile from the one or more target profiles on the remote computing device to a machine-learning model, wherein the machine-learning model may be configured to identify and store the selected target profile for future selections and may be further configured to assist the user in selecting and effectuating application of the one or more target profiles; transmit a control signal from the remote computing device to the applicator, wherein the control signal may be configured to direct a controller in the applicator to dispense the at least one media from at least one media reservoir, wherein the dispensing may comprise: instructing an air source to supply a predetermined quantity of pressurized air into a passage, wherein the passage may be configured to pass through a cap positioned on a head component of the applicator, expelling a predetermined quantity of the at least one media from the at least one media reservoir through a nozzle positioned within the head component, and expelling the at least one media through the cap at a predetermined angle of spread, wherein the at least one media may be atomized into a mist upon contact with the pressurized air as it passes through a tapered region within the cap of the head component; and apply the atomized mist of the at least one media to the user.

In some cases, the head component of the non-transient computer-readable storage medium, may further comprises a head control system comprising a coupling structure for joining an actuating lever to the needle, wherein the actuating lever may be configured to slidingly engage with the needle to further control expulsion of the at least one media from the applicator.

In some cases, the body of the non-transient computer-readable storage medium may further comprises a reservoir lid that may comprising a sealing structure that may be configured to form a hermetic seal between the reservoir lid and one or more side walls of the at least one media reservoir when the reservoir lid is optionally in a closed position.

In some cases, the head and the body of the non-transient computer-readable storage medium may be joined by a keyed coupling assembly, the keyed coupling assembly may comprise: a plurality of protrusions and a plurality of recesses that may be configured to mate the head and the body, wherein: the plurality of recesses may be further configured to permit vertical mating of the plurality of protrusions of the head with the plurality of protrusions of the body when the plurality of protrusions and the plurality of recesses are in alignment, and rotation of the head or the body past a first, predefined degree of rotation may decouple the head from the body.

In some cases, the at least one media reservoir of the non-transient computer-readable storage medium may further comprise two or more sub-chambers that may be configured to hold the at least one media in each sub-chamber, and at least one dividing structure that may be configured to separate the at least one media in each sub-chamber.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An applicator, comprising:
one or more sensors configured to provide real-time mapping data as the applicator moves from a first position relative to a user's face or body to at least a second position relative to the user's face or body;
a head component comprising:
at least one media reservoir configured to contain at least one media;
a reservoir lid positioned above the at least one media;
a nozzle comprising a tubular structure configured to facilitate passage of the at least one media from the at least one media reservoir;
a head control system coupled to and controlling a position of a needle within the nozzle;
wherein the needle is in concert with the nozzle effectuate atomization of the at least one media as the at least one media exits the nozzle;
a cap positioned at least partially downstream of the nozzle and configured to facilitate passage of the at least one media from the applicator, wherein the cap comprises a sub-cap positioned within the cap and around at least a portion of the nozzle and is configured to increase pressure at a tip of the nozzle; and
an air constriction component positioned upstream from the tip of the nozzle and configured to present a reduction in diameter of a passage area; and
a body component removably engaged with the head component, wherein the body component comprises:
an air source configured to supply pressurized air through the passage area, wherein the at least one media is atomized via the pressurized air and exits the applicator through the cap;
one or more circuitry components housing at least one hardware processor and configured to distribute power from a power source within the applicator.

2. The device of claim 1, wherein the one or more sensors comprise at least one of a Light Detection and Ranging (LIDAR) sensor and one or more cameras.

3. The device of claim 1, wherein the head control system comprises a solenoid for converting inputs of a flow control lever into movements of the needle.

4. The device of claim 3, wherein the cap further comprises:
an ovular opening with a center of the ovular opening offset from the nozzle in a vertical direction, wherein the offset is configured to adjust a spray pattern of the atomized media in an upward direction relative to the nozzle.

5. The device of claim 1, wherein the applicator reduces functionality from two to one speed when a battery charge falls below a threshold.

6. The device of claim 1, wherein the head component and the body component are joined by a keyed coupling assembly, the keyed coupling assembly comprising:
a plurality of protrusions and a plurality of recesses configured to mate the head component and the body component, wherein:
the plurality of recesses are further configured to permit vertical mating of the plurality of protrusions of the head component with the plurality of protrusions of the body component when the plurality of protrusions and the plurality of recesses are in alignment, and
rotation of the head component or the body component past a first, predefined degree of rotation will decouple the head component from the body component.

7. The device of claim 1, wherein the air source is an air pump positioned within the body component and configured to operate within a pressure range of 12-24 PSI or between 15-20 PSI and an air flow range of 5-8 LPM.

8. The device of claim 5, wherein the applicator further comprises at least one selector configured to allow a user to power on and power off the applicator and select between two or more powered modes of the air source, wherein:
a first mode of the two or more powered modes comprises a first air speed or motor RPM, and
a second mode of the two or more powered modes comprises a second air speed or motor RMP greater than the first mode.

9. The device of claim 1, wherein the at least one media reservoir further comprises two or more sub-chambers, wherein the two or more sub-chamber are configured to contain at least one media in each sub-chamber.

10. The device of claim 9, wherein outputs of the two or more sub-chambers are mixed in different ratios to achieve different output colors for the applicator.

11. A system configured for applying cosmetics, the system comprising:
one or more hardware processors configured by machine-readable instructions to:
receive data from one or more sensors of an applicator in real time as the applicator moves from a first position relative to a user's body to at least a second position relative to the user's body;
process the data to determine a data map of the user; and
transmit the data map of the user to a remote computing device comprising a display, the computing device configured to receive user inputs related to application of one or more media to a portion of the user's body corresponding to the data map;
wherein the display presents the data map of the user and is configured to permit the user to select one or more target profiles, the one or more target profiles comprising at least one virtual overlay of one or more media as applied to the user;
transmit the selected target profile to a machine-learning model, wherein the machine-learning model is configured to identify and store the selected target profile for future selections and is further configured to assist the user in selecting and effectuating application of the one or more target profiles with the applicator;
use the selected target profile and feedback from the machine-learning model, to control a rate or pressure of air expelled from an air source in the applicator as well as a position of a needle in the applicator, the rate or pressure of air and needle position influencing the applicator's spray pattern to assist the user in effectuating the target profile.

12. The system of claim 11, wherein a head of the applicator is removable from a body of the applicator and comprises a head control system that converts user inputs into movement of the needle.

13. The system of claim 12, wherein the head control system mechanically couples a lever to the needle.

14. The system of claim 12, wherein the head control system receives a user input, digitizes the user input, and controls a position of the needle based on the digitized input.

15. The system of claim 12, wherein a head and a body are joined by a keyed coupling assembly, the keyed coupling assembly comprising:
a plurality of protrusions and a plurality of recesses configured to mate the head and the body, wherein:
the plurality of recesses are further configured to permit vertical mating of the plurality of protrusions of the head with the plurality of protrusions of the body when the plurality of protrusions and the plurality of recesses are in alignment, and
rotation of the head or the body past a first, predefined degree of rotation will decouple the head from the body.

16. The system of claim 11, further comprising at least one media reservoir, wherein the at least one media reservoir comprises two or more sub-chambers, the two or more sub-chamber configured to contain at least one media in each sub-chamber.

17. The system of claim 16, wherein outputs of the two or more sub-chambers are mixed in different ratios to achieve different output colors for the applicator.

18. A non-transient computer-readable storage medium having instructions embodied thereon, the instructions being executable by one or more processors configured to perform a method for applying cosmetics, the method comprising:
receiving a target profile comprising at least one preselected user input; and
dispensing at least one media from at least one media reservoir in an applicator, wherein the dispensing comprises:
scanning a portion of a user's body via one or more sensors positioned on the applicator, wherein the one or more sensors are configured to provide readings of distance and angle or position of the applicator in real time as the applicator moves from an initial position relative to the user's body to at least a second position relative to the user's body,
developing a map of the portion of the user's body, by comparing the readings to a datastore on a computing device;
instructing an air source to pass pressurized air through a passage in a head portion of the applicator that passes an orifice on a bottom of the at least one media reservoir, this air movement drawing additional media into the passage, the air source being in the body portion of the applicator and the at least one media reservoir and passage being in a head portion of the applicator, and
instructing an actuator of a head control system to position a needle within the passage to pass the at least one media through a nozzle and through a cap in the head portion at a rate and an angle of spread corresponding to the (1) target profile, (2) the map of the portion of the user's body, and (3) the readings of the one or more sensors in real time, wherein the at least one media is atomized into a mist as it exits the applicator.

19. The non-transient computer-readable storage medium of claim 18, wherein the head control system further comprises:
a media flow control lever configured to manually control the rate of flow of media from the at least one media reservoir.

20. The non-transient computer-readable storage medium of claim 18, wherein the head and the body are joined by a keyed coupling assembly, the keyed coupling assembly comprising:
a plurality of protrusions and a plurality of recesses configured to mate the head and the body, wherein:
the plurality of recesses are further configured to permit vertical mating of the plurality of protrusions of the head with the plurality of protrusions of the body when the plurality of protrusions and the plurality of recesses are in alignment, and
rotation of the head or the body past a first, predefined degree of rotation will decouple the head from the body.

21. The non-transient computer-readable storage medium of claim 18, wherein the at least one media reservoir further comprises two or more sub-chambers configured to contain the at least one media in each sub-chamber, and at least one dividing structure configured to separate the at least one media in each sub-chamber.

22. The non-transient computer-readable storage medium of claim 18, wherein the computing device is in the body of the applicator.

23. The non-transient computer-readable storage medium of claim 18, wherein the computing device is remote from the applicator.
